(19) United States
(12) Patent Application Publication
(10) Pub. No.: US 2026/0244186 A1
(43) Pub. Date: Aug. 20, 2026

(54) PROGRAM EDITING DEVICE, MACHINE TOOL, AND PROGRAM EDITING METHOD

(71) Applicant: FANUC CORPORATION, Yamanashi (JP)

(72) Inventor: Yuuta IMAMATSU, Yamanashi-ken (JP)

(21) Appl. No.: 18/872,392

(22) PCT Filed: Jun. 23, 2022
(86) PCT No.: PCT/JP2022/025171

§ 371 Date: Dec. 6, 2024

(51) Int. Cl. G05B 19/408; B23Q 11/10

(52) U.S. Cl. CPC G05B 19/4083; B23Q 11/10

(57) ABSTRACT

A program editing device includes a mist amount acquiring unit that acquires a mist amount; a period detecting unit that detects a first period during which a mist collector is operating while the mist amount is smaller than a first threshold; and a program editing unit that automatically edits a machining program so that the mist collector does not operate in the first period.

### TECHNICAL FIELD

The present invention relates to a program editing device, a machine tool, and a program editing method.

### BACKGROUND ART

A mist collector collects mist generated within a machining area of a machine tool (refer also to JP 2012-076006 A). The mist collector collects the mist within the machining area, and prevents the mist from leaking out to the exterior of the machining area. The mist is a coolant of fine or minute particles that are suspended within the air.

### SUMMARY OF THE INVENTION

In order to reliably prevent the mist from leaking out to the exterior of the machining area, the mist collector is often driven over a prolonged time period. However, the mist collector, by being operated over a prolonged time period, consumes a large amount of electric power.

An object of the present invention is to solve the aforementioned problem.

A first aspect of the present invention is a program editing device that edits a machining program configured to control an operation of a mist collector of a machine tool, the machine tool including a machining device configured to machine a workpiece, and the mist collector configured to collect mist present in a machining area of the machining device, the program editing device including a mist amount acquisition unit configured to acquire an amount of the mist collected by the mist collector based on a detection signal of a first mist sensor, a period detection unit configured to detect a first period in which the mist collector operates in a state in which the amount of the mist is less than a first threshold, and a program editing unit configured to automatically edit the machining program in order for the mist collector not to operate during the first period.

A second aspect of the present invention is a machine tool including the above-mentioned program editing device according to the first aspect, the machining device, the mist collector, and a control device configured to control the machining device and the mist collector based on the machining program.

A third aspect of the present invention is a program editing method for editing a machining program configured to control an operation of a mist collector of a machine tool, the machine tool including a machining device configured to machine a workpiece, and the mist collector configured to collect mist present in a machining area of the machining device, the method including a mist amount acquisition step of acquiring an amount of the mist collected by the mist collector based on a detection signal of a first mist sensor, a first period detection step of detecting a first period in which the mist collector operates in a state in which the amount of the mist is less than a first threshold, and a program editing step in which a computer automatically edits the machining program in order for the mist collector not to operate during the first period.

According to the present invention, it is possible to suppress the electric power consumption of the machine tool equipped with the machining device and the mist collector.

### BRIEF DESCRIPTION OF DRAWINGS

FIG. 1 is a schematic diagram of a machine tool according to an embodiment;

FIG. 2 is a block diagram showing a control device (program editing device), a drive device, and a plurality of motors;

FIG. 3 is a block diagram showing a control device (a program editing device), a drive device, and a plurality of motors;

FIG. 4 is a first graph illustrating time transition of an amount of mist;

FIG. 5 is a second graph illustrating time transition of the amount of mist;

FIG. 6 is a first graph illustrating time transition of an accumulation amount;

FIG. 7 is a second graph illustrating time transition of the accumulation amount;

FIG. 8 is a flowchart illustrating a program editing method according to the embodiment;

FIG. 9 is a flowchart illustrating a determination step;

FIG. 10 is a schematic diagram of a machine tool according to Exemplary Modification 1;

FIG. 11 is a block diagram of a control device according to Exemplary Modification 2;

FIG. 12 is a block diagram of a control device according to Exemplary Modification 3;

FIG. 13 is a block diagram of a program editing device according to Exemplary Modification 4;

FIG. 14 is a flowchart illustrating a program editing method according to a fifth modification;

FIG. 15 is a third graph illustrating time transition of the accumulation amount; and

FIG. 16 is a fourth graph illustrating time transition of the accumulation amount.

### DETAILED DESCRIPTION OF THE INVENTION

### Embodiment

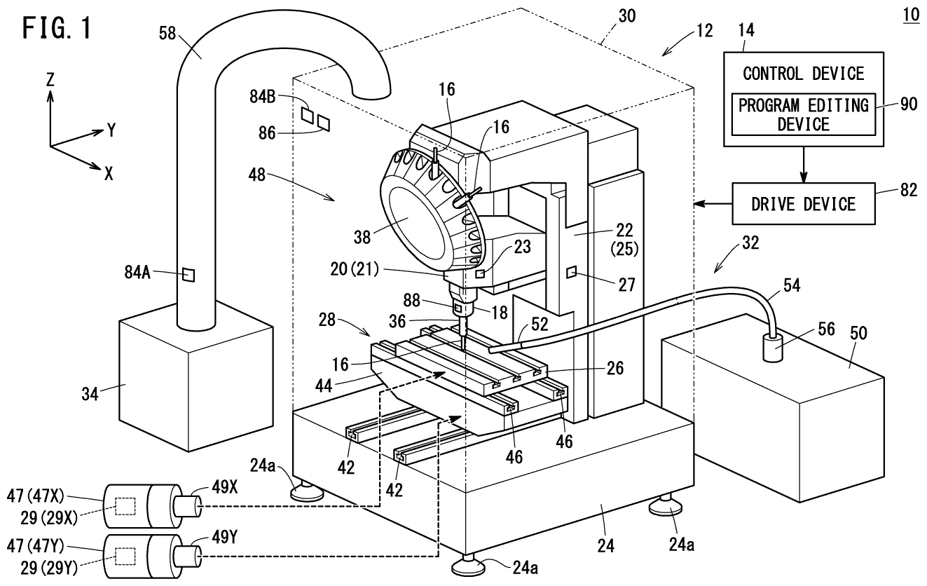

FIG. 1 is a schematic diagram of a machine tool 10 according to an embodiment.

The X direction and the Y direction shown in FIG. 1 are directions that are parallel to a horizontal plane. The X direction and the Y direction are mutually perpendicular to each other. The Z direction shown in FIG. 1 is a direction that is parallel to the direction of gravity. Accordingly, the Z direction is perpendicular to the X direction and the Y direction. However, the Z direction shown in FIG. 1 indicates a direction that is opposite to the direction of gravity.

The machine tool 10 is provided with a machining device 12, a control device 14, a coolant supply device 32, and a mist collector 34.

The machining device 12 is a machine that carries out machining on a workpiece using a tool 16. The machining device 12 includes a spindle 18, a spindle head 20, a column 22, a pedestal 24, a table 26, a table drive unit 28, and a cover 30.

A tool holder 36 is attached to the spindle 18 (refer to FIG. 1). The tool holder 36 is capable of being attached and detached to and from the spindle 18. The tool holder 36 retains the tool 16. The tool 16, for example, is a spring-necked turning tool, a drill, an end mill, a milling cutter, or the like.

The machining device 12 is further equipped with a tool magazine 38. The tool magazine 38 detachably retains a plurality of the tools 16. One of the plurality of tools 16 retained by the tool magazine 38 is mounted on the tool holder 36.

The spindle head 20 supports the spindle 18. The spindle head 20 is provided with a spindle motor 21 for rotating the spindle 18. The spindle motor 21 is, for example, a spindle motor. The spindle motor 21 includes a shaft (not shown) and an encoder 23.

The shaft of the spindle motor 21 rotates by the electric power supplied to the spindle motor 21. The spindle 18 rotates in accordance with the rotation of the shaft of the spindle motor 21. As the spindle 18 rotates, the tool 16 mounted via the tool holder 36 on the spindle 18 rotates.

The encoder 23 is a rotary encoder. The encoder 23 outputs a detection signal corresponding to the rotational position of the shaft of the spindle motor 21.

The column 22 is supported on the pedestal 24. The column 22 supports the spindle head 20. The column 22 includes a column motor 25. The column motor 25 is, for example, a servo motor. The column motor 25 includes a shaft (not shown) and an encoder 27.

The shaft of the column motor 25 rotates by the electric power supplied to the column motor 25. The column 22 moves in the Z direction in accordance with the rotation of the shaft of the column motor 25. When the column 22 moves in the Z direction, the spindle 18 supported by the column 22 moves in the Z direction.

The encoder 27 is a rotary encoder. The encoder 27 outputs a detection signal corresponding to the rotational position of the shaft of the column motor 25.

The pedestal 24 is provided on the installation surface. The installation surface, for example, is a floor of a factory. The installation surface may be a support surface of a platform that is provided on the floor. The installation surface extends, for example, parallel to the horizontal plane. The pedestal 24 may be equipped with a plurality of leg members 24a. Each of the leg members 24a, for example, may be a caster, a jack, or the like.

The table drive unit 28 is supported on the pedestal 24. The table drive unit 28 includes a plurality of feed axis motors 47 (47X, 47Y), a first slide unit 42, a saddle 44, and a second slide unit 46.

The plurality of feed axis motors 47 includes a Y-axis motor 47Y and an X-axis motor 47X. The Y-axis motor 47Y and the X-axis motor 47X are, for example, servo motors. The Y-axis motor 47Y includes a rotating shaft 49Y. The X-axis motor 47X includes a rotating shaft 49X.

The first slide unit 42 is provided on the pedestal 24. The first slide unit 42 includes, for example, guide rails that extend in the Y direction. The first slide unit 42 supports the saddle 44.

The saddle 44 is connected to the Y-axis motor 47Y. The saddle 44 moves in the Y direction in response to the driving of the Y-axis motor 47Y. The saddle 44 moves while being guided by the first slide unit 42.

The second slide unit 46 is provided on the saddle 44. The second slide unit 46 includes, for example, guide rails that extend in the X direction. The second slide unit 46 supports the table 26.

The table 26 supports a non-illustrated workpiece downwardly of the spindle 18. The table 26 is connected to an X-axis motor 47X. The table 26 moves in the X direction in response to the driving of the X-axis motor 47X. The table 26 moves while being guided by the second slide unit 46.

The cover 30 covers the spindle 18, the spindle head 20, the column 22, the pedestal 24, the table 26, and the table drive unit 28. Consequently, the cover 30 forms a machining area 48. A workpiece is machined within the machining area 48.

The cover 30 is further equipped with a non-illustrated door and a non-illustrated window. The operator can carry out an introduction operation etc. of the workpiece into the machining area 48 through the door that is in an opened state. Further, the operator can easily confirm the condition within the machining area 48 via the window.

The coolant supply device 32 is a device that supplies the coolant to the machining area 48. The coolant supply device 32 is equipped with a coolant tank 50, a nozzle 52, a supply pipe 54, and a pump 56.

The coolant tank 50 stores the coolant. The coolant tank 50 is provided externally of the machining area 48.

The nozzle 52 is a discharge unit that discharges the coolant. The nozzle 52 is disposed within the machining area 48. The coolant supply device 32 may include a plurality of nozzles 52.

The supply pipe 54 is a pipe that connects the coolant tank 50 and the nozzle 52. Moreover, the coolant supply device 32 may be equipped with a plurality of the supply pipes 54. The number of the supply pipes 54 is determined, for example, in accordance with the number of the nozzles 52. The supply pipe 54 connects the coolant tank 50 and the nozzle 52.

The pump 56 is connected to the supply pipe 54. The pump 56 draws in the coolant within the coolant tank 50, and delivers the coolant to the nozzle 52. Consequently, the coolant is discharged from the nozzle 52 into the machining area 48.

The coolant that is discharged into the machining area 48 cools the tool 16 and the workpiece. When machining is carried out in the machining area 48, a mist of the coolant is generated. There is a concern that the mist may leak out to the exterior of the machining area 48 via small gaps that occur in the machining device 12.

The mist collector 34 is a device that serves to collect the mist within the machining area 48. The mist collector 34 is provided outside the machining area 48. Further, the mist collector 34 is connected to the cover 30 via a duct 58. The mist collector 34 collects the mist by drawing in air within the machining area 48. In accordance with this feature, the mist is prevented from leaking out to the exterior of the machining area 48.

By the tool 16 cutting the workpiece, fine or minute cutting chips are generated in the form of powdery dust within the machining area 48. There is a concern that the powdery dust, in the same manner as the mist, may leak out to the exterior of the machining area 48 via small gaps that occur in the machining device 12. The mist collector 34, by drawing in air within the machining area 48, may collect not only the mist, but also the powdery dust. In accordance with this feature, the powdery dust is prevented from leaking out to the exterior of the machining area 48.

The mist collector 34 may be connected to the coolant tank 50. Consequently, the mist that is collected by the mist collector 34 can be returned, as the coolant, to the coolant tank 50.

In the case that the mist collector 34 and the coolant tank 50 are connected to each other, it is preferable for the mist collector 34 and the coolant tank 50 to be connected to each other via a non-illustrated filtering device (filter). The filtering device removes impurities in the coolant sent from the mist collector 34 to the coolant tank 50. By connecting the mist collector 34 and the coolant tank 50 via the filtering device, a clean coolant can be returned from the mist collector 34 to the coolant tank 50. Impurities in the coolant, for example, are the cutting chips that have been collected together with the mist.

The control device 14 is a computer that controls the machining device 12, the coolant supply device 32, and the mist collector 34. The control device 14, for example, is a numerical control device. A more detailed description of the control device 14 will be presented later.

The machine tool 10 further includes a drive device 82, a first mist sensor 84A, a second mist sensor 84B, a temperature sensor 86, a runout amount sensor 88, and a program editing device 90. The program editing device 90 is provided in the control device 14.

The drive device 82 includes a plurality of amplifiers. The plurality of amplifiers include, for example, an amplifier for the spindle motor 21, an amplifier for the column motor 25, an amplifier for the Y-axis motor 47Y, and an amplifier for the X-axis motor 47X. In the following description, when it is not necessary to distinguish the spindle motor 21, the column motor 25, the Y-axis motor 47Y, and the X-axis motor 47X, each of the spindle motor 21, the column motor 25, the Y-axis motor 47Y, and the X-axis motor 47X is also simply referred to as a motor MO. In the following description, when it is not necessary to distinguish the encoder 23, the encoder 27, and an encoder 29, each of the encoder 23, the encoder 27, and the encoder 29 is also simply referred to as the encoder EN.

The control device 14 outputs a command for driving each motor MO to the drive device 82 based on a machining program 72 (described later). The drive device 82 supplies electric power to each motor MO based on the command output from the control device 14. Each motor MO is driven using the electric power supplied from the drive device 82.

Each of the encoders EN outputs a detection signal in accordance with the driving of the motor MO provided with the corresponding encoder EN. The drive device 82 calculates an error between the driving state of the motor MO and the command of the control device 14, based on the detection signal supplied from the encoder EN. Specifically, for example, the drive device 82 calculates an error between the rotation amount of the shaft 49X indicated by the control device 14 and the actual rotation amount of the shaft 49X. The drive device 82 adjusts the amount of electric power supplied to the motor MO so that the error is reduced. The drive device 82 adjusts the amount of electric power supplied to each of the motors MO so that the error is reduced in each of the motors MO. The control device 14 may calculate the error.

The first mist sensor 84A outputs a detection signal corresponding to a mist amount MA1, which is the amount of mist collected by the mist collector 34. In the present embodiment, the amount of mist or the mist amount more specifically refers to as a mist concentration.

The first mist sensor 84A is provided outside the machining area 48. More specifically, the first mist sensor 84A is provided on the path of collecting the mist that is collected by the mist collector 34. For example, as shown in FIG. 1, the first mist sensor 84A is provided in the duct 58.

The second mist sensor 84B is provided in the machining area 48. The second mist sensor 84B outputs a detection signal corresponding to the accumulation amount of mist in the machining area 48. The above-mentioned accumulation amount of mist is also referred to as an accumulation amount MA2 in the following description unless otherwise specified. The accumulation amount MA2 is the amount of mist accumulated in the machining area 48. More specifically, the accumulation amount MA2 is the concentration of the mist in the machining area 48.

The temperature sensor 86 is provided in the machining area 48. The temperature sensor 86 outputs a detection signal corresponding to the temperature in the machining area 48.

The runout amount sensor 88 outputs a detection signal corresponding to the amount of runout of the rotating spindle 18. The runout amount of the spindle 18 is a range of the runout of the spindle 18 while the spindle 18 is rotating. More precisely, the runout amount of the spindle 18 is a range of the runout relating to the axis of rotation of the tool 16 rotating together with the spindle 18.

The runout amount sensor 88 includes, for example, a vibration sensor, a camera (image sensor), and the like. In the case that the runout amount sensor 88 is a vibration sensor, the vibration sensor is provided on, for example, the spindle 18. In the case that the spindle 18 is provided with a vibration sensor, the runout amount of the spindle 18 is calculated based on, for example, the vibration of the spindle 18.

In the case that the runout amount sensor 88 is a camera, the camera is installed so that the spindle 18 (the tool 16) is positioned within the imaging range of the camera. It is preferable for the tool 16 mounted on the spindle 18 to be included in the imaging range of the camera. In the case that a camera is used as the runout amount sensor 88, the runout amount of the spindle 18 is calculated based on the image data of the camera.

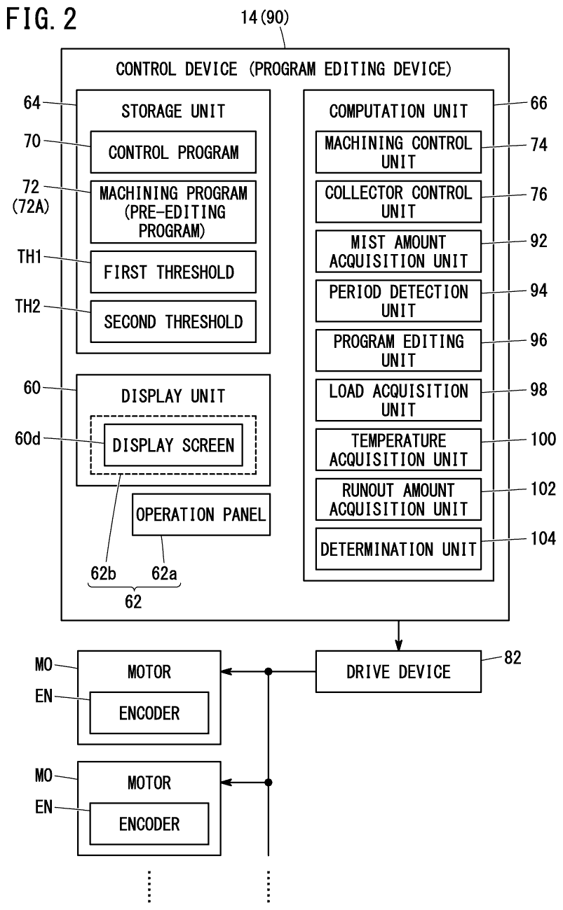

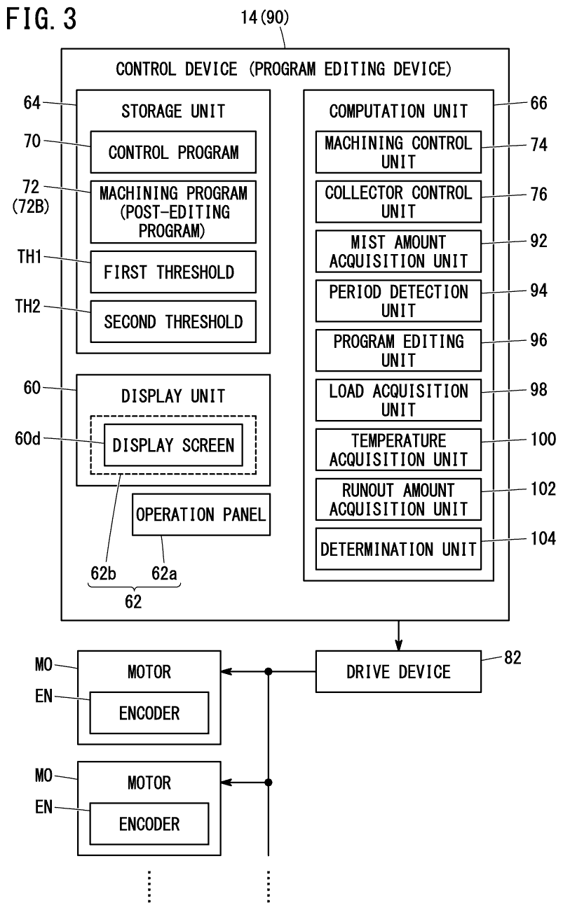

FIGS. 2 and 3 are block diagrams showing the control device 14 (program editing device 90), the drive device 82, and the plurality of motors MO. FIG. 2 shows an example of a case where a pre-editing program 72A, which will be described later, is used as the machining program 72. FIG. 3 shows an example of a case where a post-editing program 72B, which will be described later, is used as the machining program 72.

The control device 14 includes a display unit 60, an operation unit 62, a storage unit 64, and a computation unit 66.

The display unit 60 is a display device equipped with a display screen 60d. The display unit 60, for example, is a liquid crystal display device or an OEL (Organic Electro-Luminescence) display device.

The operation unit 62 is an input device that receives instructions from the operator to the control device 14. The operation unit 62 includes, for example, an operation panel 62a, and a touch panel 62b or the like. The touch panel 62b is provided on the display screen 60d. The operation unit 62 (the operation panel 62a) may be equipped with a keyboard, a mouse, or the like.

The storage unit 64 is constituted by a non-illustrated volatile memory, and a non-illustrated nonvolatile memory. As an example of the volatile memory, there may be cited a random access memory (RAM) or the like. As an example of the nonvolatile memory, there may be cited a ROM (Read Only Memory) and a flash memory or the like. Data and the like may be stored, for example, in the volatile memory. A program, a data table, a map and the like may be stored, for example, in the nonvolatile memory. At least a portion of the storage unit 64 may be provided in the aforementioned processor, an integrated circuit, or the like. The storage unit 64 stores a control program 70, the machining program 72, a first threshold TH1, and a second threshold TH2.

The control program 70 is a program for causing the control device 14 to execute the program editing method according to the present embodiment. The program editing method will be described in more detail later.

The machining program 72 includes the content for the machine tool 10 to perform predetermined machining. More specifically, the machining program 72 includes a plurality of control commands for controlling the machining device 12, the coolant supply device 32, and the mist collector 34.

For example, as described above, the machine tool 10 is provided with the plurality of motors MO for the machining device 12 to machine a workpiece. The machining program 72 includes a plurality of control commands for causing each motor MO to perform a predetermined operation.

The plurality of control commands for controlling the mist collector 34 include, for example, a start command and a stop command. The start command is a control command for starting the mist collector 34. For example, the start command is a command for starting the mist collector 34 when a predetermined time has elapsed since the machining device 12 started machining. The stop command is a control command for stopping the mist collector 34.

The plurality of control commands for controlling the coolant supply device 32 include, for example, a control command for starting the coolant supply device 32 (pump 56) and a control command for stopping the coolant supply device 32 (pump 56). As with the mist collector 34, the coolant supply device 32 may be controlled in accordance with the passage of machining time or the progress of machining.

The first threshold TH1 is, for example, an upper limit value of the mist amount MA1 at which the mist does not leak out of the machining area 48 even when the mist collector 34 is stopped. The second threshold TH2 is, for example, an upper limit value of the accumulation amount MA2 at which the mist does not leak out of the machining area 48 even when the mist collector 34 is stopped. The first threshold TH1 and the second threshold TH2 are predetermined by an operator or the like based on, for example, an experiment or the like. The first threshold TH1 and the second threshold TH2 determined by the operator or the like are input to the control device 14 through, for example, the operation unit 62. The first threshold TH1 and the second threshold TH2 may be set based on, for example, information provided by the manufacturer of the machine tool 10.

The computation unit 66 is constituted by a processor including, for example, a CPU (Central Processing Unit), and a GPU (Graphics Processing Unit) or the like. More specifically, the computation unit 66 can be constituted by a processing circuit (Processing Circuitry).

The computation unit 66 is equipped with a machining control unit 74 and a collector control unit 76. The machining control unit 74 and the collector control unit 76 are realized by the computation unit 66 executing the control program 70. Moreover, at least a portion of the machining control unit 74 and the collector control unit 76 may be realized by an integrated circuit such as an ASIC (Application Specific Integrated Circuit), an FPGA (Field-Programmable Gate Array), or the like. At least a portion of the machining control unit 74 and the collector control unit 76 may be constituted by an electronic circuit including a discrete device.

The machining control unit 74 controls the machining device 12 (drive device 82) and the coolant supply device 32 based on the machining program 72. Thus, the machining control unit 74 performs a predetermined machining operation based on the machining program 72. For example, the machining control unit 74 issues a command to the drive device 82 based on the machining program 72. Thus, the drive device 82 controls the plurality of motors MO based on the command of the machining control unit 74.

The collector control unit 76 controls the mist collector 34 based on the machining program 72. For example, the collector control unit 76 controls the mist collector 34 based on a start command. As a result, the mist collector 34 is started. The mist collector 34, which has been started, collects the mist in the machining area 48.

The computation unit 66 further includes a mist amount acquisition unit 92, a period detection unit 94, a program editing unit 96, a load acquisition unit 98, a temperature acquisition unit 100, a runout amount acquisition unit 102, and a determination unit 104. The load acquisition unit 98, the temperature acquisition unit 100, the runout amount acquisition unit 102, and the determination unit 104 constitute the program editing device 90. The mist amount acquisition unit 92, the period detection unit 94, the program editing unit 96, the load acquisition unit 98, the temperature acquisition unit 100, the runout amount acquisition unit 102, and the determination unit 104 are implemented by the computation unit 66 executing the control program 70. However, at least a part of the mist amount acquisition unit 92, the period detection unit 94, the program editing unit 96, the load acquisition unit 98, the temperature acquisition unit 100, the runout amount acquisition unit 102, and the determination unit 104 may be configured by the above-described integrated circuit, discrete device, or the like.

The mist amount acquisition unit 92 acquires information indicating the mist amount MA1. The mist amount MA1 is the amount of mist collected by the mist collector 34. In other words, the mist amount MA1 is the amount of mist sucked out of the machining area 48 and flowing toward the mist collector 34. The mist amount acquisition unit 92 acquires information indicating the mist amount MA1 based on the detection signal of the first mist sensor 84A. The storage unit 64 may store the information indicating the mist amount MA1.

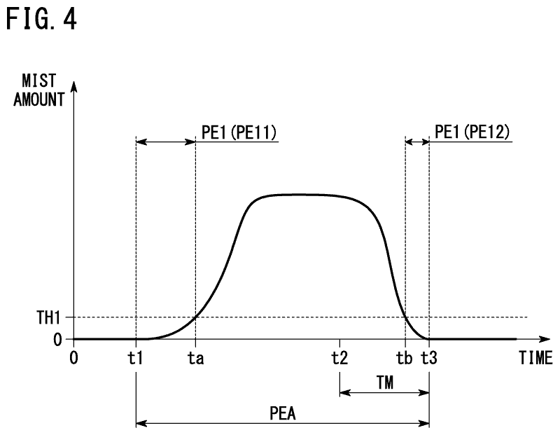

FIG. 4 is a first graph illustrating the time transition of the mist amount MA1. The vertical axis of FIG. 4 indicates the mist amount MA1. As described above, the mist amount MA1 is, for example, the amount of mist detected by the first mist sensor 84A provided in the duct 58. The horizontal axis in FIG. 4 indicates time.

The mist amount acquisition unit 92 sequentially acquires information indicating the mist amount MA1. As a result, for example, the graph of FIG. 4 is acquired. In FIG. 4, a time point t1, a time point t2, a time point t3, and a predetermined time period TM are shown. The time point t1 indicates the start time of the machining performed by the machining control unit 74. The time point t2 indicates the end time of the machining performed by the machining control unit 74. The time point t3 is a point in time after the time point t2 by the predetermined time period TM.

In FIG. 4, an operating period PEA is further shown. The operating period PEA is a period in which the mist collector 34 is driven based on the machining program 72. As shown in FIG. 4, the operating period PEA is a period from the time point t1 to the time point t3. That is, as shown in FIG. 4, the mist collector 34 continues to operate for a predetermined time period TM even after the machining control unit 74 finishes the machining. By intentionally continuing to operate the mist collector 34 for the predetermined time period TM even after the machining control unit 74 has finished machining, it is possible to suppress insufficient recovery of the mist.

The period detection unit 94 detects the first period PE1. The first period PE1 is a period in which the mist amount MA1 is less than the first threshold TH1 (condition 1-1) and the mist collector 34 is operating (condition 1-2).

The period detection unit 94 detects the first period PE1 based on the operating state of the mist collector 34, the mist amount MA1, and the first threshold TH1. The operating state of the mist collector 34 is information indicating whether the mist collector 34 is operating or stopped. The period detection unit 94 can acquire the operating state of the mist collector 34 based on, for example, a history of the control performed by the collector control unit 76. The history of the control performed by the collector control unit 76 is stored appropriately by, for example, the storage unit 64.

In the example shown in FIG. 4, two first periods PE1 are detected. For the sake of distinction, in FIG. 4 and the following description, one of the two first periods PE1 is also referred to as the first period PE11. On the other hand, the other of the two first periods PE1 is also described as the first period PE12.

The storage unit 64 may store information indicating the detected first period PE1. The storage unit 64 may store information indicating the operating period PEA.

The program editing unit 96 automatically edits the machining program 72 based on the detected first period PE1. More specifically, the program editing unit 96 automatically edits the machining program 72 so that the mist collector 34 does not operate in a period corresponding to the first period PE1 within the period from the time point t1 to the time point t3.

The machining program 72 obtained by the editing with the program editing unit 96 is also referred to as the post-editing program 72B. On the other hand, the machining program 72 before being edited with the program editing unit 96 is also referred to as the pre-editing program 72A.

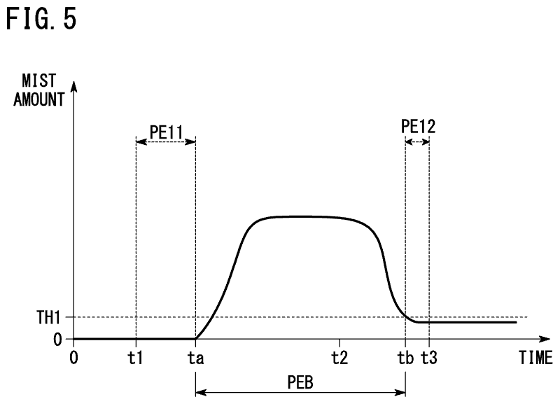

FIG. 5 is a second graph illustrating the time transition of the mist amount MA1. As described above, the mist amount MA1 is, for example, the amount of mist detected by the first mist sensor 84A provided in the duct 58. The format of this graph is similar to that of the graph shown in FIG. 4.

When the post-editing program 72B is executed, a graph shown in FIG. 5, for example, is obtained. In FIG. 5, a time point ta, a time point tb, and an operating period PEB are shown. The time point ta in FIG. 5 corresponds to the time point ta in FIG. 4. The time point ta in FIG. 4 is a point in time when the mist amount MAI, which was smaller than the first threshold TH1, has increased to the first threshold TH1. The time point tb in FIG. 5 corresponds to the time point tb in FIG. 4. The time point tb in FIG. 4 is a point in time when the mist amount MA1 which was larger than the first threshold TH1 falls to the first threshold TH1. The operating period PEB indicates a period in which the mist collector 34 is driven based on the post-editing program 72B.

The operating period PEB is a period from the time point ta to the time point tb. The period from the time point ta to the time point tb is a part of the period from the time point t1 to the time point t3. Thus, the operating period PEB is shorter than the operating period PEA. By shortening the operating time of the mist collector 34, the electric power consumption of the mist collector 34 is suppressed. By suppressing the electric power consumption of the mist collector 34, the electric power consumption of the machine tool 10 is also suppressed.

The period other than the operating period PEB in the period from the time point t1 to the time point t3 is a period in which the mist collector 34 does not operate. The risk of leakage of the mist to the outside of the machining area 48 during the period in which the mist collector 34 is not operated decreases as the first threshold TH1 decreases.

As described above, the period detection unit 94 may detect a plurality of the first periods PE1. However, it is more preferable for each of the first periods PE1 to be a period that continues for a predetermined time period or more. That is, even if the period is a period during which the mist collector 34 is operating in a state where the mist amount MA1 is less than the first threshold TH1, it is preferable for the period not to be treated as the first period PE1 when the period is short. This suppresses an increase in the frequency of turning on and off the mist collector 34. As a result, the control load of the machine tool 10 is suppressed.

The load acquisition unit 98 acquires information indicating the load of at least one predetermined motor MO among the plurality of motors MO. The load acquisition unit 98 acquires load information indicating the load of the motor MO based on a detection signal output from the load sensor corresponding to the load of the motor MO. The load of the motor MO is, for example, the amount of power consumption of the motor MO. Therefore, the load acquisition unit 98 may acquire information indicating the amount of power consumption of at least one predetermined motor MO among the plurality of motors MO as the information indicating the load.

The amount of power consumption of each of the plurality of motors MO is adjusted by the drive device 82 based on the detection signal of the encoder EN provided in each motor MO. In this case, the load acquisition unit 98 can acquire information indicating the amount of power consumption of each of the motors MO from the drive device 82. Each of the encoders EN used for adjusting the amount of power consumption functions as a load sensor.

The load acquisition unit 98 sequentially acquires the load information during a period (from the time point t1 to the time point t2) in which the machining control unit 74 performs machining. The storage unit 64 cumulatively stores the load information sequentially acquired by the load acquisition unit 98.

The temperature acquisition unit 100 acquires information indicating the temperature in the machining area 48 based on the detection signal of the temperature sensor 86. The temperature acquisition unit 100 sequentially acquires information indicating the temperature during a period (from the time point t1 to the time point t2) in which the machining control unit 74 performs machining. The storage unit 64 cumulatively stores information indicating temperatures sequentially acquired by the temperature acquisition unit 100.

The runout amount acquisition unit 102 acquires information indicating the runout amount of the spindle 18 based on the detection signal of the runout amount sensor 88. The runout amount acquisition unit 102 sequentially acquires information indicating the runout amount during a period (from the time point t1 to the time point t2) in which the machining control unit 74 performs machining. The storage unit 64 cumulatively stores information indicating the runout amount.

The determination unit 104 determines whether or not a predetermined condition is satisfied in the machining performed after the program editing unit 96 has edited the machining program 72. The determination unit 104 determines that the predetermined condition is satisfied when at least one of the conditions 2-1 to 2-4 described in order below is satisfied.

The condition 2-1 is that the second load LO2 is greater than the first load LO1. It is preferable to further add a condition that the difference between the first load LO1 and the second load LO2 is equal to or greater than a predetermined value, to the condition 2-1.

The first load LO1 is a load in the machining based on the pre-editing program 72A. The second load LO2 is a load in the machining based on the post-editing program 72B. Each of the first load LO1 and the second load LO2 may be a load in a predetermined period (predetermined process) of the machining period, which is a period during which machining is performed. As described above, the load is a load (amount of power consumption) of at least one predetermined motor MO among a plurality of the motors MO provided in the machine tool 10. In order to determine whether or not the condition 2-1 is satisfied, the determination unit 104 compares the maximum value of the first load LO1 and the maximum value of the second load LO2, for example. The maximum value of the load of the motor MO is the instantaneous maximum power consumption (maximum electricity power) of the motor MO.

By adding the condition that the difference between the first load LO1 and the second load LO2 is equal to or greater than a predetermined value, to the condition 2-1, the error between the first load LO1 and the second load LO2 is allowed. By allowing the error between the first load LO1 and the second load LO2, it is possible to prevent the determination that the condition 2-1 is satisfied even though the first load LO1 and the second load LO2 are not much different.

The condition 2-2 is that a second temperature change amount dT2 is larger than a first temperature change amount dT1. It is preferable to add a condition that the difference between the first temperature change amount dT1 and the second temperature change amount dT2 is equal to or greater than a predetermined value, to the condition 2-2.

The first temperature change amount dT1 is the amount of change in the temperature in the machining area 48 during the machining based on the pre-editing program 72A. The second temperature change amount dT2 is the amount of change in the temperature in the machining area 48 during the machining based on the post-editing program 72B. Each of the first temperature change amount dT1 and the second temperature change amount dT2 may be an amount of change in the temperature in the machining area 48 during a predetermined period (predetermined process) of the machining period, which is a period during which machining is performed.

By adding the condition that the difference between the first temperature change amount dT1 and the second temperature change amount dT2 is equal to or greater than a predetermined value, to the condition 2-2, the error between the first temperature change amount dT1 and the second temperature change amount dT2 is allowed. By allowing the error between the first temperature change amount dT1 and the second temperature change amount dT2, it is possible to prevent the determination that the condition 2-2 is satisfied even though the first temperature change amount dT1 and the second temperature change amount dT2 are not much different.

The condition 2-3 is that a second runout amount RA2 is larger than a first runout amount RA1. It is preferable to add a condition that the difference between the first runout amount RA1 and the second runout amount RA2 is equal to or greater than a predetermined value, to the condition 2-3.

The first runout amount RA1 is a runout amount of the spindle 18 when the machining based on the pre-editing program 72A is performed. The second runout amount RA2 is a runout amount of the spindle 18 when the machining based on the post-editing program 72B is performed. Each of the first runout amount RA1 and the second runout amount RA2 may be a runout amount of the spindle 18 in a predetermined period (predetermined process) of a machining period in which machining is performed. In order to determine whether or not the condition 2-3 is satisfied, the determination unit 104 compares the maximum value of the first runout amount RA1 and the maximum value of the second runout amount RA2, for example.

By adding the condition that the difference between the first runout amount RA1 and the second runout amount RA2 is equal to or greater than a predetermined value, to the condition 2-3, the error between the first runout amount RA1 and the second runout amount RA2 is allowed. By allowing the error between the first runout amount RA1 and the second runout amount RA2, it is possible to prevent the determination that the condition 2-3 is satisfied even though the first runout amount RA1 and the second runout amount RA2 are not much different.

The condition 2-4 is that a second period PE2 (PE22) when the machining is performed based on the post-editing program 72B is longer than a second period PE2 (PE21) when the machining is performed based on the pre-editing program 72A. It is preferable to add a condition that the difference between the second period PE21 when the machining is performed based on the pre-editing program 72A and the second period PE22 when the machining is performed based on the post-editing program 72B is equal to or greater than a predetermined value, to the condition 2-4.

The second period PE2 is a period during which the accumulation amount MA2 is equal to or greater than the second threshold TH2 during machining. The second period PE2 is detected by the period detection unit 94 based on the accumulation amount MA2 and the second threshold TH2. The accumulation amount MA2 used by the period detection unit 94 to detect the second period PE2 is acquired by the mist amount acquisition unit 92 based on the detection signal of the second mist sensor 84B. The second period PE2 may include at least a part of the period from the time point t2 (see FIG. 4) to the time point t3 (see FIG. 4).

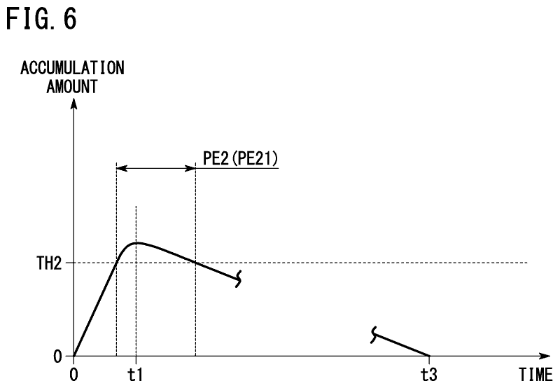

FIG. 6 is a first graph illustrating the time transition of the accumulation amount MA2. The vertical axis of FIG. 6 indicates the accumulation amount MA2. As described above, the accumulation amount MA2 is the amount of mist accumulated in the machining area 48. The horizontal axis in FIG. 6 indicates time.

The second period PE21 is a period in which the accumulation amount MA2 is equal to or more than the second threshold TH2 when the machining is performed based on the pre-editing program 72A. FIG. 6 shows the time transition of the accumulation amount MA2 and the second period PE21 in the case where the pre-editing program 72A is used. As shown in FIG. 6, the accumulation amount MA2 increases after the start of machining. This is because mist is generated in the machining area 48 when the workpiece is machined. Also, as shown in FIG. 6, the accumulation amount MA2 decreases after the time point t1. This is because the mist collector 34 starts to collect the mist in the machining area 48 at the time point t1.

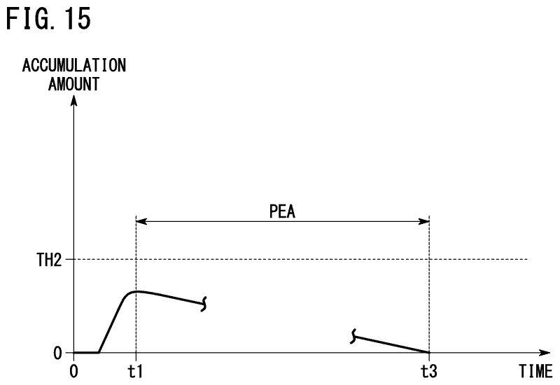

The accumulation amount MA2 shown in FIG. 6 starts to increase immediately after the start of machining and reaches the second threshold TH2 at a point in time before the time point t1. However, depending on the content of the pre-editing program 72A, the accumulation amount MA2 does not exceed the second threshold TH2 until the machining is completed (see also an exemplary modification example described later and FIG. 15). In this case, the length of the second period PE21 is zero.

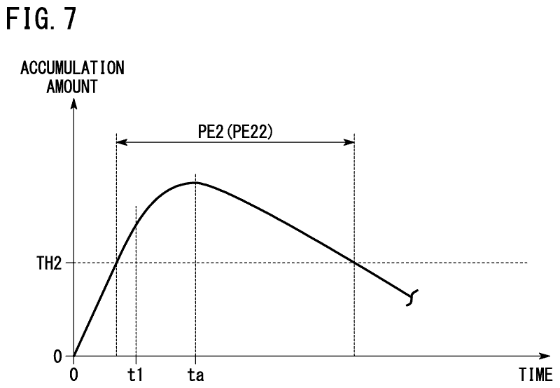

FIG. 7 is a second graph illustrating the time transition of the accumulation amount MA2. The format of this graph is similar to that of the graph shown in FIG. 6.

The second period PE22 is a period in which the accumulation amount MA2 is equal to or more than the second threshold TH2 when the machining is performed based on the post-editing program 72B. FIG. 7 shows the time transition of the accumulation amount MA2 and the second period PE22 in the case where the post-editing program 72B is used. The accumulation amount MA2 in FIG. 7 increases after the start of the machining, as in the case of FIG. 6. This is because mist is generated in the machining area 48 when the workpiece is machined. As shown in FIG. 7, the accumulation amount MA2 also increases in the period from the time point t1 to the time point ta. The reason is that the mist collector 34 is not operated in the period from the time point t1 to the time point ta because the machining program 72 has been edited. As shown in FIG. 7, the accumulation amount MA2 decreases after the time point ta.

By adding the condition that the difference between the second period PE21 and the second period PE22 is equal to or greater than a predetermined value, to the condition 2-4, the error between the second period PE21 and the second period PE22 is allowed. By allowing the error between the second period PE21 and the second period PE22, it is possible to prevent the determination that the condition 2-4 is satisfied even when the second period PE21 and the second period PE22 are not much different.

It is more preferable for the second period PE2 to be a period that continues for a predetermined time period or more. That is, even when the accumulation amount MA2 is equal to or more than the second threshold TH2, it is preferable for the period not to be treated as the second period PE2 when the period is short.

When at least one of the conditions 2-1 to 2-4 is satisfied, the program editing unit 96 restores the machining program 72 to the state before being edited. That is, when the determination unit 104 determines that the predetermined condition is satisfied, the program editing unit 96 restores the machining program 72 used in machining from the post-editing program 72B to the pre-editing program 72A.

The reason why the machining program 72 used in machining is restored from the post-editing program 72B to the pre-editing program 72A in the case where the predetermined condition is satisfied, is as follows.

While the machining is being performed, the air in the machining area 48 is warmed by the heat generated in accordance with the machining. The heated air in the machining area 48 is discharged to the outside of the machining area 48 together with the mist by the operation of the mist collector 34. That is, the mist collector 34 not only collects the mist but also serves to ventilate the machining area 48.

The program editing unit 96 edits the machining program 72, thereby shortening the operating period of the mist collector 34. When the operating period of the mist collector 34 is shortened, the electric power consumption of the mist collector 34 is suppressed as described above, but heat tends to be trapped in the machining area 48.

The heat in the machining area 48 thermally expands the articles and equipment provided in the machining device 12. For example, the heat in the machining area 48 thermally expands the workpiece, the tool 16, and the like. The thermal expansion of the workpiece, the tool 16, and the like causes the bite of the tool 16 into the workpiece to vary. The amount of power consumption of the plurality of motors MO provided in the machining device 12 varies as the way the tool 16 bites into the workpiece varies. As a result of the variation in the amount of power consumption of the plurality of motors MO, the amount of power consumption of the machine tool 10 when the machining is performed based on the post-editing program 72B may be larger than the amount of power consumption of the machine tool 10 when the machining is performed based on the pre-editing program 72A. Further, the machine accuracy varies due to thermal expansion of the workpiece, the tool 16, and the like.

Based on the above reason, in the case that the above conditions 2-1, 2-2, and the like are satisfied, there is a higher possibility that the electric power consumption of the machine tool 10 can be suppressed more by performing machining using the pre-editing program 72A than by performing machining using the post-editing program 72B. In the present embodiment, therefore, when the conditions 2-1, 2-2 and the like are satisfied, the machining program 72 used in machining is restored from the post-editing program 72B to the pre-editing program 72A.

The variation of cutting resistance also affects the runout amount of the spindle 18. Therefore, in the present embodiment, even when the above-described condition 2-3 is satisfied, also the machining program 72 used in machining is restored from the post-editing program 72B to the pre-editing program 72A.

Further, when the mist is accumulated in the machining area 48, heat is more likely to be trapped in the machining area 48 than when the mist is not present in the machining area 48. The increase in the accumulation amount MA2 increases the risk of the mist leaking out of the machining area 48. In view of this, in the present embodiment, even when the condition 2-4 is satisfied, the post-editing program 72B is restored to the pre-editing program 72A.

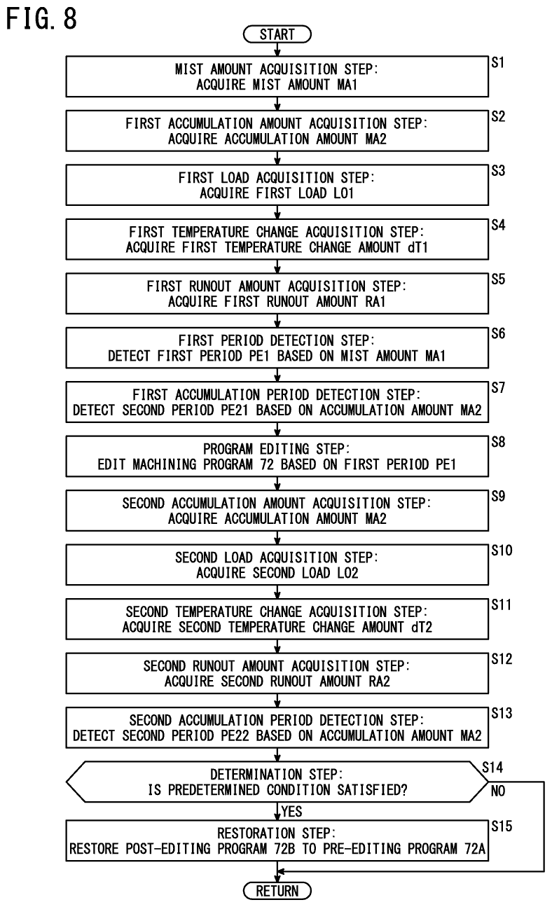

FIG. 8 is a flowchart illustrating a program editing method according to the embodiment.

The program editing device 90 can perform, for example, the program editing method illustrated in FIG. 8. The program editing method includes a mist amount acquisition step (S1), a first accumulation amount acquisition step (S2), a first load acquisition step (S3), a first temperature change acquisition step (S4), and a first runout amount acquisition step (S5). The program editing method further includes a first period detection step (period detection step) S6, a first accumulation period (first residence time) detection step S7, and a program editing step S8. The order of execution of the steps from the mist amount acquisition step S1 to the first accumulation period detection step S7 may be changed as appropriate. However, the first period detection step S6 is executed after the mist amount acquisition step S1. The first accumulation period detection step S7 is executed after the first accumulation amount acquisition step S2.

In the mist amount acquisition step S1, the mist amount acquisition unit 92 acquires the mist amount MA1 based on the detection signal of the first mist sensor 84A. The mist amount acquisition unit 92 acquires the mist amount MA1 in the operating period PEA based on the pre-editing program 72A.

In the first accumulation amount acquisition step S2, the mist amount acquisition unit 92 acquires the accumulation amount MA2 based on the detection signal of the second mist sensor 84B. The mist amount acquisition unit 92 acquires the accumulation amount MA2 in the period from the time point t1 to the time point t3 when the mist collector 34 is controlled based on the pre-editing program 72A.

In the first load acquisition step S3, the load acquisition unit 98 acquires at least one load (first load LO1) of the plurality of motors MO. As described above, the load is, for example, the amount of power consumption of the motor MO.

In the first temperature change acquisition step S4, the temperature acquisition unit 100 acquires the amount of temperature change (first temperature change amount dT1) in the machining area 48 based on the detection signal of the temperature sensor 86.

In the first runout amount acquisition step S5, the runout amount acquisition unit 102 acquires the runout amount (first runout amount RA1) of the spindle 18 based on the detection signal of the runout amount sensor 88.

In the first period detection step S6, the period detection unit 94 detects the first period PE1 based on the mist amount MA1 acquired in the mist amount acquisition step S1.

In the first accumulation period detection step S7, the period detection unit 94 detects the second period PE21 based on the accumulation amount MA2 acquired in the first accumulation amount acquisition step S2.

In the program editing step S8, the program editing unit 96 automatically edits the pre-editing program 72A based on the first period PE1. The program editing unit 96 edits the pre-editing program 72A so that the mist collector 34 does not operate in a state where the mist amount MA1 is less than the first threshold TH1. In this way, the program editing unit 96 creates the post-editing program 72B.

The program editing method shown in FIG. 8 further includes a second accumulation amount acquisition step S9, a second load acquisition step S10, a second temperature change acquisition step S11, a second runout amount acquisition step S12, and a second accumulation period (second residence time) detection step S13. The program editing method further includes a determination step S14 and a restoration step S15.

In the second accumulation amount acquisition step S9, the mist amount acquisition unit 92 acquires the accumulation amount MA2 based on the detection signal of the second mist sensor 84B. The mist amount acquisition unit 92 acquires the accumulation amount MA2 during the period from the time point t1 to the time point t3 when the mist collector 34 is controlled based on the post-editing program 72B.

In the second load acquisition step S10, the load acquisition unit 98 acquires at least one load (second load LO2) of the plurality of motors MO.

In the second temperature change acquisition step S11, the temperature acquisition unit 100 acquires the amount of temperature change (second temperature change amount dT2) in the machining area 48 based on the detection signal of the temperature sensor 86.

In the second runout amount acquisition step S12, the runout amount acquisition unit 102 acquires the runout amount (second runout amount RA2) of the spindle 18 based on the detection signal of the runout amount sensor 88.

In the second accumulation period detection step S13, the period detection unit 94 detects the second period PE22 based on the accumulation amount MA2 acquired in the second accumulation amount acquisition step S9.

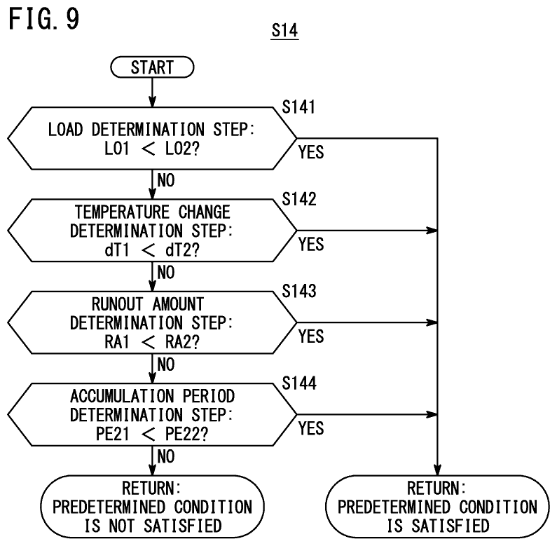

FIG. 9 is a flowchart illustrating the determination step S14.

In the determination step S14, the determination unit 104 determines whether or not the predetermined condition is satisfied. The determination step S14 includes a load determination step S141, a temperature change determination step S142, a runout amount determination step S143, and an accumulation period determination step S144. The order of the load determination step S141, the temperature change determination step S142, the runout amount determination step S143, and the accumulation period determination step S144 is not specified.

In the load determination step S141, the determination unit 104 determines whether or not the second load LO2 is larger than the first load LO1.

In the temperature change determination step S142, the determination unit 104 determines whether or not the second temperature change amount dT2 is larger than the first temperature change amount dT1.

In the runout amount determination step S143, the determination unit 104 determines whether or not the second runout amount RA2 is larger than the first runout amount RA1.

In the accumulation period determination step S144, the determination unit 104 determines whether or not the second period PE22 based on the post-editing program 72B is longer than the second period PE21 based on the pre-editing program 72A.

In the case that the determination results in all of the load determination step S141, the temperature change determination step S142, the runout amount determination step S143, and the accumulation period determination step S144 are NO, the determination unit 104 determines that the predetermined condition is not satisfied (S14: NO). In this case, the program editing device 90 terminates the program editing method.

When the determination result is YES in at least one of the load determination step S141, the temperature change determination step S142, the runout amount determination step S143, and the accumulation period determination step S144, the determination unit 104 determines that the predetermined condition is satisfied (S14 of FIG. 8: YES). In this case, the program editing unit 96 starts the restoration step S15 after the determination step S14.

In the restoration step S15, the program editing unit 96 restores the post-editing program 72B to the pre-editing program 72A. When the restoration step S15 is completed, the program editing device 90 ends the program editing method.

According to the present embodiment, the program editing unit 96 edits the pre-editing program 72A so as to suppress the power consumption of the mist collector 34. Thus, the post-editing program 72B is obtained. By using the post-editing program 72B, the control device 14 can suppress the power consumption of the mist collector 34.

However, there may be a case where the power consumption of the entire machine tool 10 cannot be suppressed even though the post-editing program 72B is used. In the present embodiment, in the case that any of the conditions 2-1 to 2-4 is satisfied, the program editing unit 96 restores the post-editing program 72B to the pre-editing program 72A. This makes it possible to suppress the power consumption of the entire machine tool 10.

### Exemplary Modifications

Hereinafter, a description will be given concerning exemplary modifications of the above-described embodiment. However, any descriptions that are duplicative or overlap with those of the above-described embodiment will be appropriately omitted in the following description. Unless otherwise specified, the same reference numerals as in the above-described embodiment are used in referring to the elements that have already been described in the embodiment.

### (Exemplary Modification 1)

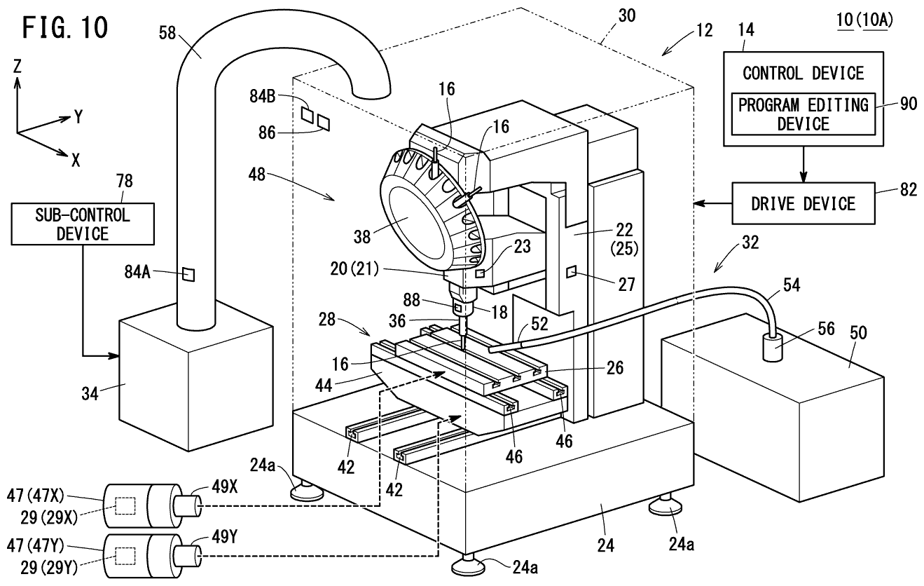

FIG. 10 is a schematic diagram of a machine tool 10 (10A) according to an exemplary modification 1.

The machine tool 10A further includes a sub-control device 78.

The sub-control device 78 is a computer that is separate from the control device 14. The sub-control device 78, for example, is equipped with a processor and a memory. The sub-control device 78 may also be equipped with an integrated circuit, a discrete device, or the like.

In the case that the control device 14 is stopped, the sub-control device 78 controls the mist collector 34 instead of the collector control unit 76. Therefore, even if the control device 14 is stopped, the mist collector 34 is controlled by the sub-control device 78 in the same manner as in the embodiment.

For example, if the main power supply of the control device 14 is turned off before the collector control unit 76 causes the mist collector 34 to be stopped, the sub-control device 78 can cause the mist collector 34 to be stopped, instead of the control device 14.

Moreover, it is preferable for the sub-control device 78 and the control device 14 to communicate with each other as appropriate, and to share the data necessary for controlling the mist collector 34. For example, the sub-control device 78 shares the progress of the machining with the control device 14. In accordance with these features, the sub-control device 78 is capable of smoothly taking over the control that was being performed by the collector control unit 76. According to the present exemplary modification, even after the control device 14 is stopped, the control of the mist collector 34 can be continued by the sub-control device 78.

### (Exemplary Modification 2)

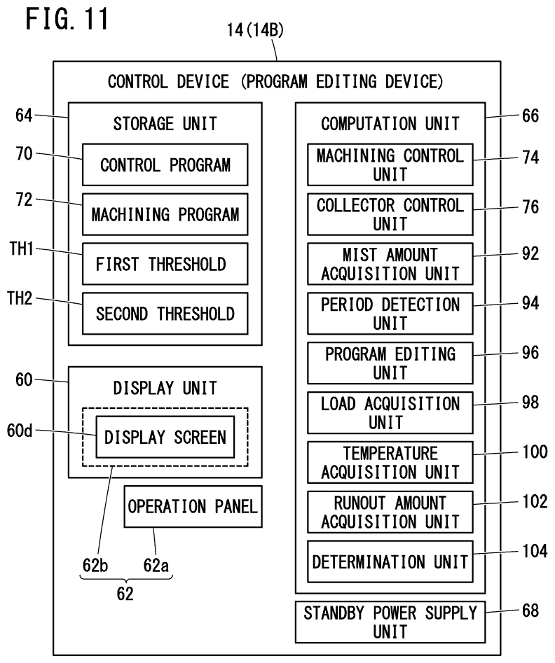

FIG. 11 is a block diagram of a control device 14 (14B) according to an exemplary modification 2.

The control device 14B further includes a standby power supply unit 68.

The standby power supply unit 68 is a power supply different from the main power supply of the control device 14B. The standby power supply unit 68 includes, for example, a battery. The standby power supply unit 68 is integrated in the control device 14B. However, the standby power supply unit 68 may be provided in the machine tool 10 as an external power supply of the control device 14B. The main power supply of the control device 14B is not shown.

In the case that the main power supply of the control device 14B is turned off while the mist collector 34 is in operation, the standby power supply unit 68 supplies electric power to each of the components of the control device 14B. In accordance with this feature, even after the main power supply has been turned off, the collector control unit 76 can continue to control the mist collector 34.

For example, the main power supply of the control device 14B may be turned off before the collector control unit 76 stops the mist collector 34. In such a case, by supplying power from the standby power supply unit 68, the collector control unit 76 can automatically stop the mist collector 34 even after the main power supply of the control device 14B is turned off. In accordance with this feature, the wasteful power consumption of the mist collector 34 is suppressed.

### (Exemplary Modification 3)

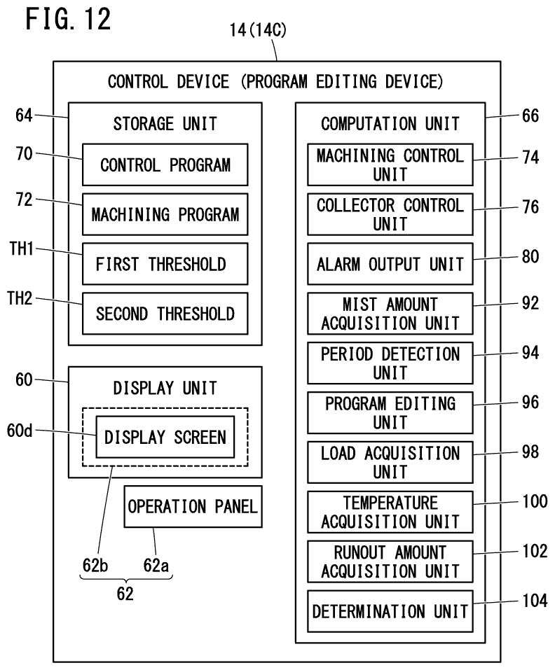

FIG. 12 is a block diagram of a control device 14 (14C) according to an exemplary modification 3.

The control device 14C is further equipped with an alarm output unit 80.

The alarm output unit 80 outputs an alarm in the case that an abnormality has occurred in the machine tool 10. For example, the machine tool 10 is appropriately provided with non-illustrated sensors for the purpose of detecting malfunctions or troubles in each of the respective components such as the spindle 18, the spindle head 20, the table drive unit 28, etc. The alarm output unit 80 determines whether or not a malfunction has occurred in the machine tool 10 based on the signals output by the sensors. In the case that a malfunction is detected in any of the respective components of the machine tool 10, the alarm output unit 80 issues a notification to the operator, for example via the display unit 60, to the effect that the malfunction has occurred.

In the case that the alarm output unit 80 has output an alarm prior to the start of the machining, the machining control unit 74 does not start the machining until the cause of the alarm is eliminated. Further, in the case that the alarm output unit 80 has output an alarm after the start of the machining, the machining control unit 74 suspends the machining based on the machining program 72 until the cause of the alarm is eliminated.

In the case that the alarm output unit 80 outputs an alarm, the collector control unit 76 prohibits the operation of the mist collector 34 until the cause of the alarm is eliminated, regardless of the content of the machining program 72. In the case that the mist collector 34 is operating at the time when the alarm is output, the collector control unit 76 causes the mist collector 34 to be stopped regardless of the content of the machining program 72.

According to the present exemplary modification, in the case that an abnormality has occurred in the machine tool 10, the mist collector 34 is prevented from operating.

### (Exemplary Modification 4)

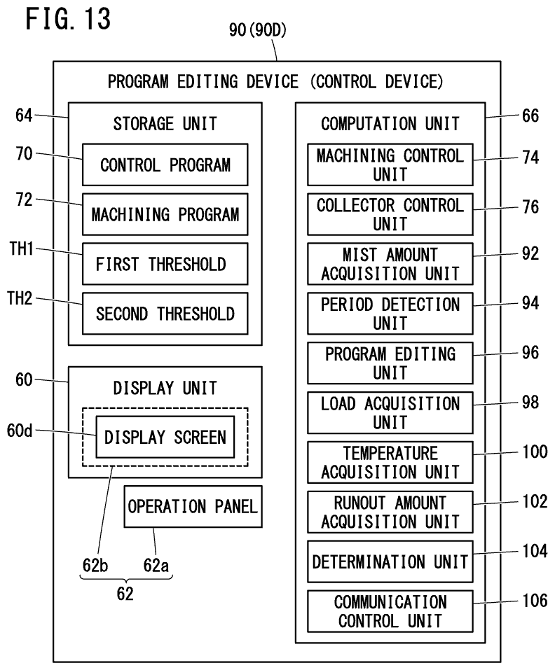

FIG. 13 is a block diagram of a program editing device 90 (90D) according to a fourth modification.

The program editing device 90D further includes a communication control unit 106.

In the case that the program editing unit 96 edits the pre-editing program 72A, the communication control unit 106 communicates with another machine tool (10) and transmits the content edited by the program editing unit 96 to the other machine tool.

For example, the storage unit 64 of each of the plurality of machine tools 10 stores the pre-editing program 72A. At least one of the plurality of machine tools 10 is provided with a program editing device 90D. In the machine tool 10 provided with the program editing device 90D, the pre-editing program 72A is edited. In such a case, the communication control unit 106 transmits the post-editing program 72B to another machine tool 10. There may be a case where there are a plurality of machine tools 10 capable of receiving the post-editing program 72B. In this case, it is preferable for the communication control unit 106 to transmit the post-editing program 72B to all the machine tools 10 that can receive the post-editing program 72B.

According to the present modification, the post-editing program 72B can be used not only by the machine tool 10 provided with the program editing device 90D but also by a machine tool (10) that is different from the machine tool 10. That is, the power consumption of the machine tool (10) other than the machine tool (10) that is provided with the program editing device (90D), can also be suppressed.

### (Exemplary Modification 5)

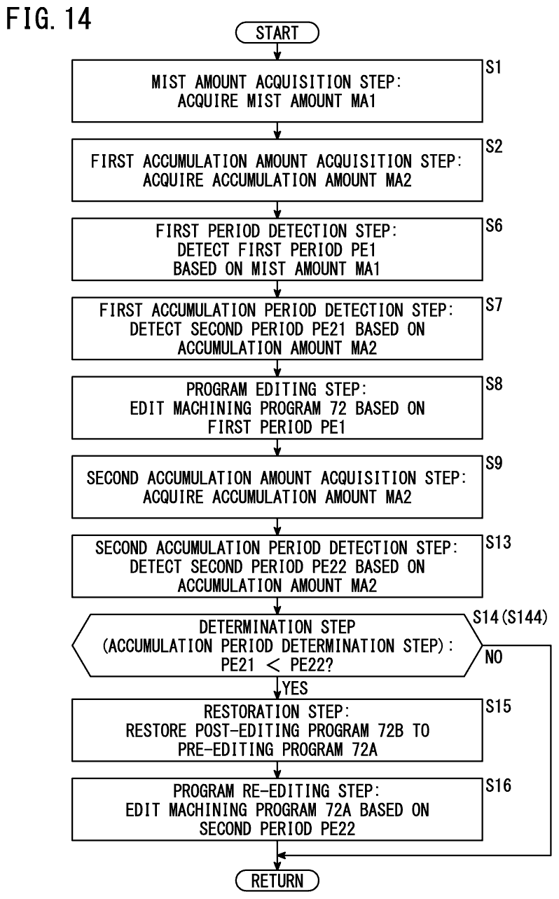

FIG. 14 is a flowchart illustrating a program editing method according to an exemplary modification 5.

The determination step S14 of FIG. 14 includes at least an accumulation period determination step S144. The program editing method of FIG. 14 further includes a program re-editing step S16. The program re-editing step S16 is started after the restoration step S15.

In the program re-editing step S16, the program editing unit 96 edits the pre-editing program 72A so that the mist collector 34 does not operate in the first period PE1.

However, the program editing unit 96 edits the pre-editing program 72A so that the mist collector 34 operates in the second period PE22. When there is an overlapping period between the first period PE1 and the second period PE22, the program editing unit 96 edits the pre-editing program 72A so that the mist collector 34 operates in the overlapping period.

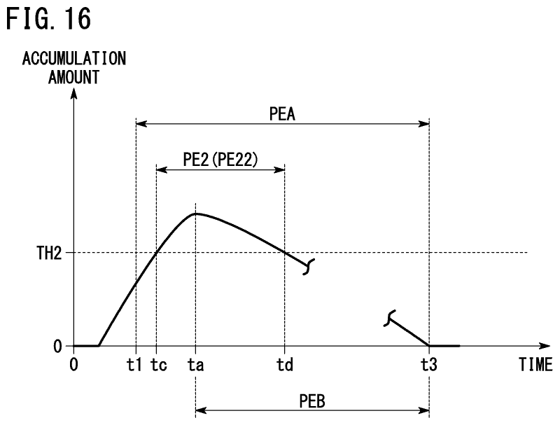

The program editing unit 96 edits the pre-editing program 72A as described below with reference to FIGS. 15 and 16, for example.

FIG. 15 is a third graph illustrating the time transition of the accumulation amount MA2. FIG. 16 is a fourth graph illustrating the time transition of the accumulation amount MA2. The format of each of the graphs shown in FIGS. 15 and 16 is similar to the format of the graph shown in FIG. 6.

FIG. 15 illustrates the transition of the accumulation amount MA2 in the case where the pre-editing program 72A is used. Although a part of the accumulation amount MA2 in FIG. 15 is omitted, the accumulation amount MA2 does not exceed the second threshold TH2 in the period from the start time (origin) of the machining to the time point t3. In contrast, FIG. 16 illustrates the transition of the accumulation amount MA2 in the case where the post-editing program 72B is used. The post-editing program 72B of FIG. 16 is obtained by the program editing unit 96 editing the pre-editing program 72A of FIG. 15.

The accumulation amount MA2 in FIG. 16 reaches the second threshold TH2 at a time point to between the time point t1 and the time point ta. The accumulation amount MA2 in FIG. 16 becomes less than the second threshold TH2 at a time point td after the time point ta. In this case, the second period PE22 according to FIG. 16 is a period from the time point tc to the time point td.

In the above case, the determination unit 104 determines that the length of the second period PE22 is longer than the length (zero) of the second period PE21. The program editing unit 96 edits the machining program 72 so that the mist collector 34 operates not only during the operating period PEB but also during the period from the time point tc to the time point ta.

In this case, a machining program 72 is obtained in which the mist collector 34 is driven for a period from the time point tc to the time point t3. The period from the time point tc to the time point t3 is shorter than the operating period PEA. Therefore, when the machining program 72 obtained in the program re-editing step S16 is used, the power consumption of the mist collector 34 can be suppressed more than when the pre-editing program 72A is used. In addition, the accumulation amount MA2 can be prevented from exceeding the second threshold TH2.

As described above, according to the present modification, the machining program 72 can suppress not only the power consumption of the mist collector 34 but also the accumulation amount MA2 so as not to exceed the second threshold TH2.

In the program re-editing step S16, the program editing unit 96 may set the point in time at which the mist collector 34 is started to a point in time a predetermined time period before the time point tc. This reduces the risk that the accumulation amount MA2 reaches the second threshold TH2. In this case, the predetermined time period is determined within a time difference between the time point t1 and the time point tc, for example.

Some steps included in the determination step S14 are omitted from the flowchart of FIG. 14. More specifically, the load determination step S141 to the runout amount determination step S143 are omitted from the flowchart of FIG. 14. However, the program editing method of the present modification may include at least one of the load determination step S141 to the runout amount determination step S143. In this case, the program editing method of the present modification also includes the first load acquisition step S3 to the first runout amount acquisition step S5, and the second load acquisition step S10 to the second runout amount acquisition step S12 as appropriate. However, even if at least one of the determination results of the load determination step S141 to the runout amount determination step S143 is YES, the accumulation period determination step S144 is performed.

### (Combination of Plural Exemplary Modifications)

The above-described plurality of exemplary modifications may be combined as appropriate within a range in which there are no contradictions therebetween.

### Modified Embodiments

It should be noted that the present invention is not limited to the above-described disclosure, and various alternative or additional configurations may be adopted without departing from the essence and gist of the present invention.

For example, according to the embodiment, the first mist sensor 84A is provided in the duct 58, but the present invention is not limited to this configuration. The first mist sensor 84A may be provided at a mist inlet of the mist collector 34 (a connecting portion between the mist collector 34 and the duct 58).

Further, for example, the first mist sensor 84A may be provided in the machining area 48. In this case, the first mist sensor 84A may also serve as the second mist sensor 84B.

Further, for example, at least a part of the drive device 82 may be provided in the control device 14.

For example, the start command included in the machining program 72 may be a command to start the mist collector 34 in the case that the progress of machining reaches a predetermined step. The stop command included in the machining program 72 may be a command to start the mist collector 34 in the case that the progress of machining reaches a predetermined step.

For example, the load acquisition unit 98 may calculate the amount of power consumption of at least one of the plurality of motors MO. In this case, at least one of the plurality of encoders EN may input a detection signal not only to the drive device 82 but also to the control device 14.

According to the embodiment, the period detection unit 94 acquires the operating state of the mist collector 34 from the collector control unit 76 in order to detect the first period PE1. However, the period detection unit 94 may detect the operating period PEA in advance based on the machining program 72. In this case, the period detection unit 94 may further detect the first period PE1 using the detected operating period PEA.

For example, a period (from the time point t2 to the time point t3 in FIG. 4) during which the mist collector 34 collects the mist after the machining is completed may be excluded from the detectable range of the first period PE1. For example, the period detection unit 94 need not necessarily detect the first period PE12 illustrated in FIG. 4. Accordingly, the mist collector 34 is reliably operated during the period from the time point t2 to the time point t3. As a result, it is possible to more reliably prevent insufficient recovery of the mist after the machining is completed. For the same reason, the program editing unit 96 may exclude the period in which the mist collector 34 collects the mist after the machining is completed from an editing target, regardless of the detection result of the period detection unit 94.

According to the embodiment, the determination unit 104 compares the maximum value of the first load LO1 with the maximum value of the second load LO2 in order to determine whether the condition 2-1 is satisfied. However, the method of determining whether or not the condition 2-1 is satisfied is not limited to the comparison between the maximum value of the first load LO1 and the maximum value of the second load LO2. For example, the determination unit 104 may compare the average value of the first load LO1 and the average value of the second load LO2 in order to determine whether or not the condition 2-1 is satisfied. The average value of the load of the motors MO is the average power consumption of the motors MO.

According to the embodiment, the determination unit 104 compares the maximum value of the first runout amount RA1 with the maximum value of the second runout amount RA2 in order to determine whether or not the condition 2-3 is satisfied. However, the method of determining whether or not the condition 2-3 is satisfied is not limited to the comparison between the maximum value of the first runout amount RA1 and the maximum value of the second runout amount RA2. For example, the determination unit 104 may compare the average value of the first runout amount RA1 and the average value of the second runout amount RA2 in order to determine whether or not the condition 2-3 is satisfied.

At least one of the plurality of motors MO may be provided with a torque sensor. The torque sensor outputs a detection signal corresponding to the output torque of the corresponding motor MO. The load acquisition unit 98 may acquire the output torque of the motor MO as the load of the motor MO. In this case, the torque sensor functions as a load sensor.

At least one of the plurality of motors MO may be provided with a current sensor. The current sensor outputs a detection signal corresponding to the drive current of the corresponding motor MO. The load acquisition unit 98 may acquire the drive current of the motor MO as the load of the motor MO. In this case, the current sensor functions as a load sensor.

At least one of the load acquisition unit 98, the temperature acquisition unit 100, and the runout amount acquisition unit 102 may be omitted from the program editing device 90. In this case, the determination unit 104 determines whether or not the predetermined condition is satisfied using at least one of the load (electric power consumption) of the motor MO, the temperature in the machining area 48, and the runout amount of the spindle 18.

The determination unit 104 may be omitted from the program editing device 90. In this case, not only the determination unit 104 but also all of the load acquisition unit 98, the temperature acquisition unit 100, and the runout amount acquisition unit 102 may be omitted from the program editing device 90.

The coolant discharge method is not limited to being that of the embodiment. For example, the coolant may be discharged using a center-through method. In that case, the coolant supply device 32 supplies the coolant to the spindle 18. Further, the coolant may flow along the inner wall of the cover 30 (the machining area 48).

For example, the machining device 12 may further be equipped with a non-illustrated recovery member in order to recover the coolant that falls downwardly of the table 26. Such a recovery member, for example, is an oil pan provided on the pedestal 24. A portion of the coolant supplied to the machining area 48 falls downwardly of the table 26 without turning into a mist. According to the present exemplary modification, it is possible to collect the coolant that has fallen downwardly of the table 26. The recovered coolant may be returned to the coolant tank 50. In accordance with this feature, the coolant supply device 32 is capable of reusing the coolant that has been collected. In this instance, it is preferable for a filtering device (a filter) to be disposed between the recovery member and the coolant tank 50. In accordance with this feature, a clean coolant can be returned to the coolant tank 50.

According to the embodiment, each of the plurality of motors MO is a rotary motor, but the present invention is not limited thereto. At least one motor MO may be a linear motor. For example, at least one of the column motor 25, the X-axis motor 47X, and the Y-axis motor 47Y may be a linear motor. In the case where the column motor 25 is a linear motor, the encoder 27 is a linear encoder. In the case where the X-axis motor 47X is a linear motor, an encoder 29X is a linear encoder. In the case where a Y-axis motor 47Y is a linear motor, the encoder 29Y is a linear encoder.

The communication control unit 106 may transmit the post-editing program 72B to at least one of the plurality of machine tools 10 that are capable of receiving the post-editing program 72B. In other words, the communication control unit 106 does not have to transmit the post-editing program 72B to all of the plurality of machine tools 10 that are capable of receiving the post-editing program 72B.

The communication control unit 106 may be provided in an electronic device separate from the program editing device 90D. The separate electronic device is, for example, a communication control device that can be externally attached to the program editing device 90. When the communication control device is externally attached to the program editing device 90, the program editing device 90 is provided with the function of the communication control unit 106.

The program editing unit 96 according to the exemplary modification 5 may edit the post-editing program 72B based on the second period PE22. In this case, the program editing unit 96 edits the post-editing program 72B so that the mist collector 34 operates in the second period PE22. In this case, the restoration step S15 is omitted.

### Invention that can be Grasped Based on the Disclosure

The invention that can be grasped based on the disclosure described above will be described below.

### <First Aspect of Invention>

A first aspect of the invention is the program editing device (90) that edits the machining program (72) configured to control the operation of the mist collector (34) of the machine tool (10), the machine tool including the machining device (12) configured to machine the workpiece, and the mist collector configured to collect mist present in the machining area (48) of the machining device, the program editing device including the mist amount acquisition unit (92) configured to acquire the amount (MA1) of the mist collected by the mist collector based on the detection signal of the first mist sensor (84A), the period detection unit (94) configured to detect the first period (PE1) in which the mist collector operates in the state in which the amount of the mist is less than the first threshold (TH1), and the program editing unit (96) configured to automatically edit the machining program in order for the mist collector not to operate during the first period.

In accordance with this feature, it is possible to suppress the electric power consumption of the machine tool equipped with the machining device and the mist collector.

In the program editing device, the mist amount acquisition unit may acquire the amount of the mist based on the detection signal of the first mist sensor disposed in the duct (58).

In the program editing device, the machining program may include the content for the machine tool to perform predetermined machining, and the machine tool may perform the predetermined machining based on the machining program, the program editing device may further include the determination unit (104) configured to determine whether the predetermined condition is satisfied in the predetermined machining performed after editing of the machining program by the program editing unit, and in the case that the predetermined condition is satisfied in the predetermined machining performed after the editing of the machining program by the program editing unit, the program editing unit may restore the machining program to a state before being edited.

In the program editing device, the machine tool may include the plurality of motors (MO) configured to be used for machining, the program editing device may further include the load acquisition unit (98) configured to acquire the load of at least predetermined one of the motors based on the detection signal of the load sensor (EN), and the determination unit may determine that the predetermined condition is satisfied, in the case that the load in the predetermined machining performed after the editing of the machining program by the program editing unit is larger than the load in the predetermined machining performed before the editing of the machining program by the program editing unit.

The program editing device may further include the temperature acquisition unit (100) configured to acquire the temperature in the machining area based on the detection signal of the temperature sensor (86), wherein the determination unit may determine that the predetermined condition is satisfied, in the case that the amount of change in the temperature in the predetermined machining performed after the editing of the machining program by the program editing unit is larger than the amount of change in the temperature in the predetermined machining performed before the editing of the machining program by the program editing unit.

The program editing device may further include the runout amount acquisition unit (102) configured to acquire the runout amount of the spindle (18) of the machining device based on the detection signal of the runout amount detection sensor (88), wherein the determination unit may determine that the predetermined condition is satisfied, in the case that the runout amount in the predetermined machining performed after the editing of the machining program by the program editing unit is larger than the runout amount in the predetermined machining performed before the editing of the machining program by the program editing unit.

In the program editing device, the mist amount acquisition unit may further acquire the accumulation amount (MA2) the mist in the machining area based on the detection signal of the second mist sensor (84B), the period detection unit may further detect the second period (PE2) in which the accumulation amount is equal to or more than the second threshold (TH2), and the determination unit may determine that the predetermined condition is satisfied, in the case that the second period in the predetermined machining performed after the editing of the machining program by the program editing unit is longer than the second period in the predetermined machining performed before the editing of the machining program by the program editing unit.

In the program editing device, the mist amount acquisition unit may further acquire the accumulation amount (MA2) of the mist in the machining area based on the detection signal of the second mist sensor (84B), the period detection unit may further detect the second period (PE2) in which the accumulation amount is equal to or more than the second threshold (TH2), and the program editing unit may edit the machining program based on the second period, in the case that the second period in the predetermined machining performed after the editing of the machining program by the program editing unit is longer than the second period in the predetermined machining performed before the editing of the machining program by the program editing unit.

In the program editing device, the mist amount acquisition unit may acquire the accumulation amount based on the detection signal of the second mist sensor disposed in the machining area.

The program editing device may further include the communication control unit (106) configured to, in the case that the machining program is edited by the program editing unit, transmit the edited machining program to the other machine tool.

### <Second Aspect of Invention>

A second aspect of invention is the machine tool (10) including the above-mentioned program editing device, the machining device, the mist collector, and the control device (14) configured to control the machining device and the mist collector based on the machining program.

In accordance with this feature, it is possible to suppress the electric power consumption of the machine tool.

In the machine tool, the program editing device may be provided in the control device.

The machine tool may further include the sub-control device (78) configured to control the mist collector in place of the control device in the case that the control device is stopped. In accordance with this feature, even in the case that the control device is stopped, an automated control of the mist collector is carried out.

### <Third Aspect of Invention>

A third aspect of invention is the program editing method for editing the machining program (72) configured to control the operation of the mist collector (34) of the machine tool (10), the machine tool including the machining device (12) configured to machine the workpiece, and the mist collector configured to collect mist present in the machining area (48) of the machining device, the method including the mist amount acquisition step (S1) of acquiring the amount (MA1) of the mist collected by the mist collector based on the detection signal of the first mist sensor (84A), the first period detection step (S6) of detecting the first period (PE1) in which the mist collector operates in the state in which the amount of the mist is less than the first threshold (TH1), and the program editing step (S8) in which the computer automatically edits the machining program in order for the mist collector not to operate during the first period.

In accordance with this feature, it is possible to suppress the electric power consumption of the machine tool equipped with the machining device and the mist collector.

### REFERENCE SIGNS LIST

10, 10A: machine tool
12: machining device
14, 14B, 14C: control device
18: spindle
34: mist collector
48: machining area
72: machining program
78: sub-control device
84A: first mist sensor
84B: second mist sensor
86: temperature sensor
88: runout amount sensor
90, 90D: program editing device
92: mist amount acquisition unit
94: period detection unit
96: program editing unit
98: load acquisition unit
100: temperature acquisition unit
102: runout amount acquisition unit
104: determination unit
106: communication control unit
EN: encoder (load sensor)
MA1: mist amount
MA2: accumulation amount
MO: Motor
PE1: first period
PE2: second period
TH1: first threshold
TH2: second threshold

1. A program editing device that edits a machining program configured to control an operation of a mist collector of a machine tool, the machine tool including a machining device configured to machine a workpiece, and the mist collector configured to collect mist present in a machining area of the machining device, the program editing device comprising:
a mist amount acquisition unit configured to acquire an amount of the mist collected by the mist collector based on a detection signal of a first mist sensor;
a period detection unit configured to detect a first period in which the mist collector operates in a state in which the amount of the mist is less than a first threshold; and
a program editing unit configured to automatically edit the machining program in order for the mist collector not to operate during the first period.

2. The program editing device according to claim 1, wherein the mist amount acquisition unit acquires the amount of the mist based on a detection signal of the first mist sensor disposed in a duct.

3. The program editing device according to claim 1, wherein the machining program includes a content for the machine tool to perform predetermined machining, and the machine tool performs the predetermined machining based on the machining program,
the program editing device further comprises a determination unit configured to determine whether a predetermined condition is satisfied in the predetermined machining performed after editing of the machining program by the program editing unit, and
in a case that the predetermined condition is satisfied in the predetermined machining performed after the editing of the machining program by the program editing unit, the program editing unit restores the machining program to a state before being edited.

4. The program editing device according to claim 3, wherein the machine tool includes a plurality of motors configured to be used for machining,
the program editing device further comprises a load acquisition unit configured to acquire a load of at least predetermined one of the motors based on a detection signal of a load sensor, and
the determination unit determines that the predetermined condition is satisfied, in a case that the load in the predetermined machining performed after the editing of the machining program by the program editing unit is larger than the load in the predetermined machining performed before the editing of the machining program by the program editing unit.

5. The program editing device according to claim 3, further comprising a temperature acquisition unit configured to acquire a temperature in the machining area based on a detection signal of a temperature sensor,
wherein the determination unit determines that the predetermined condition is satisfied, in a case that an amount of change in the temperature in the predetermined machining performed after the editing of the machining program by the program editing unit is larger than an amount of change in the temperature in the predetermined machining performed before the editing of the machining program by the program editing unit.

6. The program editing device according to claim 3, further comprising a runout amount acquisition unit configured to acquire a runout amount of a spindle the machining device based on a detection signal of a runout amount detection sensor,
wherein the determination unit determines that the predetermined condition is satisfied, in a case that the runout amount in the predetermined machining performed after the editing of the machining program by the program editing unit is larger than the runout amount in the predetermined machining performed before the editing of the machining program by the program editing unit.

7. The program editing device according to claim 3, wherein the mist amount acquisition unit further acquires an accumulation amount of the mist in the machining area based on a detection signal of a second mist sensor,
the period detection unit further detects a second period in which the accumulation amount is equal to or more than a second threshold, and
the determination unit determines that the predetermined condition is satisfied, in a case that the second period in the predetermined machining performed after the editing of the machining program by the program editing unit is longer than the second period in the predetermined machining performed before the editing of the machining program by the program editing unit.

8. The program editing device according to claim 3, wherein the mist amount acquisition unit further acquires an accumulation amount of the mist in the machining area based on a detection signal of a second mist sensor,
the period detection unit further detects a second period in which the accumulation amount is equal to or more than a second threshold, and
the program editing unit edits the machining program based on the second period, in a case that the second period in the predetermined machining performed after the editing of the machining program by the program editing unit is longer than the second period in the predetermined machining performed before the editing of the machining program by the program editing unit.

9. The program editing device according to claim 7, wherein the mist amount acquisition unit acquires the accumulation amount based on a detection signal of the second mist sensor disposed in the machining area.

10. The program editing device according to claim 1, further comprising a communication control unit configured to, in a case that the machining program is edited by the program editing unit, transmit the edited machining program to another machine tool.

11. A machine tool comprising the program editing device according to claim 1, the machining device, the mist collector, and a control device configured to control the machining device and the mist collector based on the machining program.

12. The machine tool according to claim 11, wherein the program editing device is provided in the control device.

13. The machine tool according to claim 11, further comprising a sub-control device configured to control the mist collector in place of the control device in a case that the control device is stopped.

14. A program editing method for editing a machining program configured to control an operation of a mist collector of a machine tool, the machine tool including a machining device configured to machine a workpiece, and the mist collector configured to collect mist present in a machining area of the machining device, the method comprising:
a mist amount acquisition step of acquiring an amount of the mist collected by the mist collector based on a detection signal of a first mist sensor;
a first period detection step of detecting a first period in which the mist collector operates in a state in which the amount of the mist is less than a first threshold; and
a program editing step in which a computer automatically edits the machining program in order for the mist collector not to operate during the first period.
